(19) United States
(12) Patent Application Publication
(10) Pub. No.: US 2009/0193239 A1
(43) Pub. Date: Jul. 30, 2009

(54) COUNTER CONTROL CIRCUIT, DYNAMIC RECONFIGURABLE CIRCUIT, AND LOOP PROCESSING CONTROL METHOD

(75) Inventors: Takashi HANAI, Kawasaki (JP); Shinichi Sutou, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/337,694

(22) Filed: Dec. 18, 2008

(30) Foreign Application Priority Data
Dec. 27, 2007 (JP) 2007-337065

(51) Int. Cl. G06F 9/38

(52) U.S. Cl. 712/234; 712/E09.045; 712/228

(57) ABSTRACT

A counter control circuit that controls the operation of a counter arranged in a dynamic reconfigurable circuit executing an arbitrary instruction by dynamically switching an aggregation of reconfigurable processing elements (hereinafter referred to as “PEs”) according to a context reciting a processing content of the PE and a connection content between the PEs, the counter control circuit including: keeping means for keeping an operation instruction signal when the PE executing a conditional branching computation outputs, in a context being adapted to the dynamic reconfigurable circuit, the operation instruction signal of the counter for a subsequent context; output means for outputting the operation instruction signal kept in the keeping means to the counter; and control means for causing the output means to output the operation instruction signal when the context being adapted to the dynamic reconfigurable circuit is switched to the subsequent context.

### CROSS-REFERENCE TO RELATED APPLICATIONS

This application is based upon and claims the benefit of priority from the prior Japanese Patent Application No. 2007-337065 filed on Dec. 27, 2007, the entire contents of which are incorporated herein by reference.

### BACKGROUND

1. Field

Aspects in accordance with the invention relate to a counter control circuit arranged in a dynamic reconfigurable circuit executing an arbitrary processing by dynamically switching an aggregation of reconfigurable processing elements (hereinafter referred to as “PEs”) according to a context reciting a processing content of the PE and a connection content between the PEs, and aspects further relate to a dynamic reconfigurable circuit and a loop processing control method.

2. Description of Related Art

A dynamic reconfigurable circuit (hereinafter referred to as “reconfigurable circuit”) conventionally functions to change an instruction content given to a PE in the reconfigurable circuit and a connection between PEs during operation. Information representing the instruction content given to the PE and the connection between the PEs in the reconfigurable circuit is called a context, and changing a configuration content is called a context switching.

The reconfigurable circuit can time-divisionally share the PE by switching the context, thus reducing the scale of the hardware for the entire reconfigurable circuit. Japanese Laid-Open Patent Application Publication No. 2006-18514 discloses a reconfigurable circuit consisting of multiple clusters. In the reconfigurable circuit as described above, it is possible to control the context switching in units of clusters. In the cluster, a state machine, namely, a sequencer, controls the context switching. As a result of a computation performed by the PE in the cluster, a subsequently-executed context can be changed.

A source code written in C language compiled by a reconfigurable circuit compiler is generally used to implement an application for the reconfigurable circuit. At this moment, a loop control is an especially time-consuming control among applications written in C language. Thus, the reconfigurable circuit is able to perform the loop control through a pipeline operation to shorten its processing time. Specifically, a counter is arranged in the reconfigurable circuit, so that a computation including the loop control can be controlled with an output from this counter as a starting point.

When the reconfigurable circuit performs the pipeline operation as described above, a count start instruction given to the counter starts a computation of a currently-applied context, and when the same counter stops counting, it becomes an instruction for completing the computation of the context.

### SUMMARY

Aspects in accordance with the present invention may include, a counter control circuit that controls the operation of a counter arranged in a dynamic reconfigurable circuit executing an arbitrary instruction by dynamically switching an aggregation of reconfigurable processing elements (hereinafter referred to as “PEs”) according to a context reciting a processing content of the PE and a connection content between the PEs, the counter control circuit including:

keeping means for keeping an operation instruction signal when the PE executing a conditional branching computation outputs, in a context being adapted to the dynamic reconfigurable circuit, the operation instruction signal of the counter for a subsequent context;

output means for outputting the operation instruction signal kept in the keeping means to the counter; and

control means for causing the output means to output the operation instruction signal when the context being adapted to the dynamic reconfigurable circuit is switched to the subsequent context.

Other aspects in accordance with the present invention may include, a dynamic reconfigurable circuit that executes an arbitrary instruction by dynamically switching an aggregation of reconfigurable processing elements (hereinafter referred to as “PEs”) according to a context reciting a processing content of the PE and a connection content between the PEs, the dynamic reconfigurable circuit including:

a counter for counting operations of the PE specified by the context; and

a counter control circuit for controlling the operation of the counter,

wherein the counter control circuit includes:

keeping means for keeping an operation instruction signal when the PE executing a conditional branching computation outputs, in a context being adapted to the dynamic reconfigurable circuit, the operation instruction signal of the counter for a subsequent context;

output means for outputting the operation instruction signal kept in the keeping means to the counter; and

control means for causing the output means to output the operation instruction signal when the context being adapted to the dynamic reconfigurable circuit is switched to the subsequent context.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 is an illustration describing a usage procedure of a reconfigurable circuit in accordance with aspects of the present invention;

FIG. 2 is a block diagram showing a cluster configuration of the reconfigurable circuit according to this embodiment in accordance with aspects of the present invention;

FIG. 3 is an illustration showing a usage procedure of a conditional branching register file in accordance with aspects of the present invention;

FIG. 4 is a block diagram showing a circuit configuration of the conditional branching register file in accordance with aspects of the present invention;

FIG. 5 is an illustration showing a usage procedure in a case where data in the conditional branching register file are kept in accordance with aspects of the present invention;

FIG. 6 is a timing chart showing an operation of the conditional branching register file in accordance with aspects of the present invention;

FIG. 7 is a timing chart showing an operation of the conditional branching register file including an immediate value output setting in accordance with aspects of the present invention;

FIG. 8 is an example of a source code implementing the context switching in C language in accordance with aspects of the present invention;

FIG. 9 is an illustration showing a generation procedure of a conditional branching signal for starting an address counter in accordance with aspects of the present invention; and

FIG. 10 is a block diagram showing an example of an implementation of a circuit of context 0 in accordance with aspects of the present invention.

### DESCRIPTION OF THE PREFERRED EMBODIMENTS

A counter control circuit, dynamic reconfigurable circuit, and loop processing control method in accordance with aspects of the present invention will be hereinafter described in detail with reference to the attached drawings.

The reconfigurable circuit (the dynamic reconfigurable circuit) according to this embodiment includes multiple clusters. Each of these clusters is a set of PEs that can dynamically change a PE instruction and a connection between PEs according to the context. The reconfigurable circuit works to execute the PE instruction and the connection between PEs set in the specified context, thus realizing an operation desired by a user.

In order to cause the above-described reconfigurable circuit to execute a program prepared by a user, it is necessary to compile the program according to the configuration of the reconfigurable circuit. Accordingly, a usage procedure of the reconfigurable circuit will be hereinafter described. It is assumed in this embodiment that the user prepares a program written in C language and causes the reconfigurable circuit to execute the program. Needless to say, it may also be possible to use programs written in other high-level languages. In such case, a compiler corresponding to the high-level language used to write the program should be prepared.

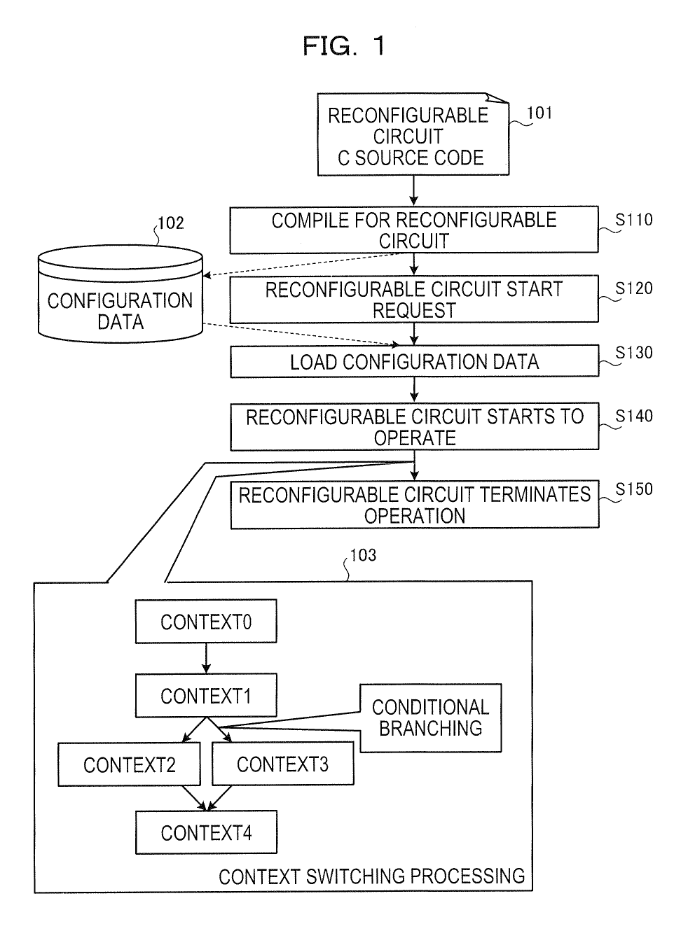

FIG. 1 is an illustration showing a usage procedure of the reconfigurable circuit. First, a reconfigurable circuit C source code 101 is prepared, as shown in FIG. 1. This reconfigurable circuit C source code 101 is a source code written in C language prepared by the user of the reconfigurable circuit.

To use the reconfigurable circuit, first, a reconfigurable circuit compiler compiles the reconfigurable circuit C source code 101 (step S110) to generate configuration data 102. The reconfigurable circuit compiler is a compiler for the reconfigurable circuit, and generates the configuration data 102 corresponding to a hardware structure of the reconfigurable circuit.

A start request for the reconfigurable circuit is subsequently issued (step S120).

And the reconfigurable circuit starts to operate (step S140).

Processes involved with step S140 will be described in detail. When each cluster starts upon the start of the reconfigurable circuit, the configuration data 102 is written to a configuration memory in each cluster. Then, the sequencer in each cluster performs a context switching processing (103) according to the configuration data 102 written in the configuration memory. When the context switching according to the configuration data 102 is completed, a series of the reconfigurable circuit operations terminates (step S150).

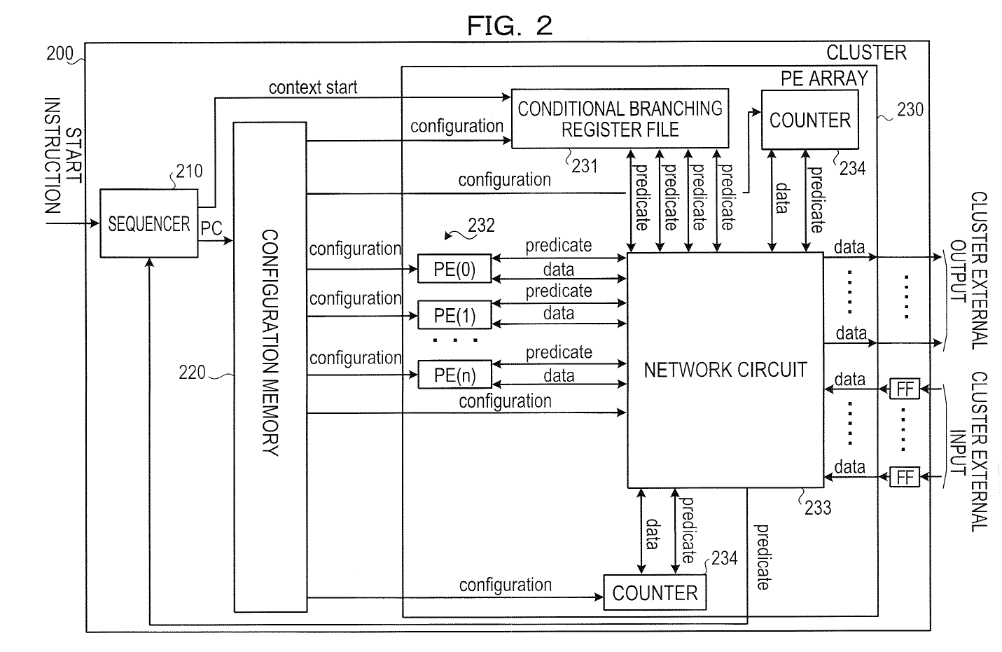

Next, a configuration of the reconfigurable circuit executing a program according to the above-described procedure will be specifically described. FIG. 2 is a block diagram showing a cluster configuration of the reconfigurable circuit according to aspects of this embodiment. The reconfigurable circuit includes multiple clusters. FIG. 2 describes the internal structure of the cluster in detail.

As shown in FIG. 2, the cluster 200 includes a sequencer 210, a configuration memory 220, and a PE array 230. The cluster 200 is input with a start instruction (signal) given from the MPU controlling the configuration data 102 executed by the reconfigurable circuit (see, FIGS. 1 and 2). The cluster 200 performs an external output to another cluster 200 of the multiple clusters 200 arranged in the reconfigurable circuit, and also receives the external output from other clusters 200.

When the sequencer 210 in the cluster 200 receives the start instruction (signal), the sequencer 210 gives a context switching instruction and changes the connection between PEs and an instruction setting in the cluster. Then, the sequencer 210 outputs a PC value to the configuration memory 220, and outputs a context start signal to the PE array 230. The PE array 230 having received the context start signal transmits a predicate signal to the sequencer 210 upon completing a processing of the set context. When the sequencer 210 receives the predicate signal, the sequencer 210 performs outputs to the configuration memory 220 and the PE array 230 as described above in order to perform switching of a subsequent context.

The configuration data 102 generated at step S110 of FIG. 1 is stored in the configuration memory 220. The configuration data 102 includes the contexts to be executed by the reconfigurable circuit. Thus, when the configuration memory 220 is input with the PC value from the sequencer 210, the configuration memory 220 outputs the configuration data 102 of the corresponding context, as a configuration signal, to each functional unit of the PE array 230.

The number of contexts differs depending on a descriptive content of the program because the context is generated by compiling the program written by the user in C language. Compiling generates the context based on the hardware structure of the reconfigurable circuit. Thus, in this embodiment, the compiler generates the context based on a structure of the cluster 200 of the reconfigurable circuit.

The PE array 230 is a functional unit performing computation according to a setting of the context, and includes a conditional branching register file 231, PEs 232, a network circuit 233, and counters 234. The conditional branching register file 231 is a functional unit unique to this embodiment, and functions as a counter control circuit. Specifically, when a conditional branching computation is performed, the conditional branching register file 231 functions to keep a computation result so that a counter for a subsequent context can operate. An operational example and a structure of the conditional branching register file 231 will be described in detail later.

The PE 232 is an operator, and performs a computation specified by the configuration signal input from the configuration memory 220. The network circuit 233 connects the conditional branching register file 231, the PEs 232, and the counters 234 in the PE array 230 according to the configuration signal input from the configuration memory 220. The counter 234 counts operations specified by the configuration signal input from the configuration memory 220.

Of the constituent elements in the above-described PE array 230, PEs 232 and counters 234 are arranged in multiple numbers. In the PE array 230, data signals are transmitted and received via the network circuit 233 so as to communicate the computation result of the PE 232 and a circuit output of the counter 234, namely, a count value. Connections of the data signals can be dynamically changed by the network circuit 233.

Next, the predicate signal for performing control in the PE array 230 and for giving the context switching instruction to the sequencer 210 will be described. The predicate signal is a 2-bit signal, and is a control signal in the cluster for instructing a comparison result and context start/end in the PE 232. A destination of connection of the predicate signal can also be dynamically changed by the network circuit 233.

The context start instruction (signal) from the sequencer 210 is converted by the conditional branching register file 231 into a 2-bit signal to become the predicate signal. The converted predicate signal is output to the PEs 232 and the counter 234 via the network circuit 233. At this moment, the predicate signal specifically represents following meanings.

2′b=“11”: established (true)

2′b=“10”: not established (false)

2′b=“01”, “00”: invalid (invalid), i.e., having no meaning

When the PE 232 performs a loop computation in the cluster 200 having the structure as described above, the counter 234 is caused to count processings of the PE. At this moment, the conditional branching register file 231 switches, according to a previous context result, the predicate signal for causing the counter 234 to start counting. The above-described structure enables performing a conditional branching control in the same context.

(Usage Procedure of the Conditional Branching Register File)

Accordingly, the usage procedure of the conditional branching register file 231 will be hereinafter described with an actual example that the conditional branching control is performed in the same context using the conditional branching register file 231.

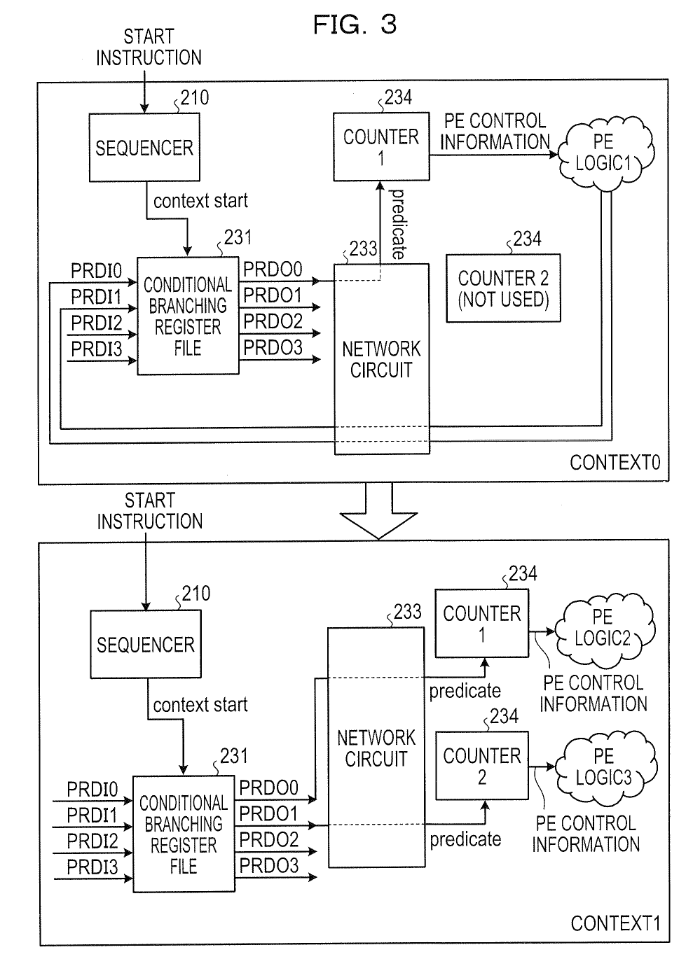

FIG. 3 is an illustration showing the usage procedure of the conditional branching register file. In FIG. 3, context 0 is an initial context, and an input of the start instruction of the cluster, as a trigger, starts the first counter 234. At this moment, the conditional branching register file 231 outputs via PRDO0 a value (2′b=“11”), as the predicate signal, set by the configuration signal input from the configuration memory 220 when the cluster starts (when the start instruction is input). The output predicate signal is input, as one pulse, to the first counter 234 via the network circuit 233.

In response to an input of one pulse of the predicate signal, the first counter 234 starts a counting operation, and outputs PE control information to a PE logic. A combination of multiple PEs, namely, a computation flow (a PE logic 1) operates with the output from this first counter 234 as a starting point. According to a computation result, the PE logic 1 writes the predicate signal (2′b 11) to an input terminal of the conditional branching register file 231, namely, any one of PRDI0 and PRDI1. Upon the operation as described above, context 0 terminates.

Next, when context 1 starts, the start instruction of context 1 is input to the conditional branching register file 231. At this moment, the conditional branching register file 231 outputs to an output terminal the predicate signal kept through the operation of context 0. Herein, the output terminal is PRDO0 in a case of the signal written to PRDI0, and the output terminal is PRDO1 in a case of the data written to PRDI1.

Thus, the output of the PE in context 0 is kept in the conditional branching register file 231, so that it becomes possible to switch operation to either of the first counter 234 and the second counter 234 according to a state of the predicate signal.

(Circuit Configuration of the Conditional Branching Register File)

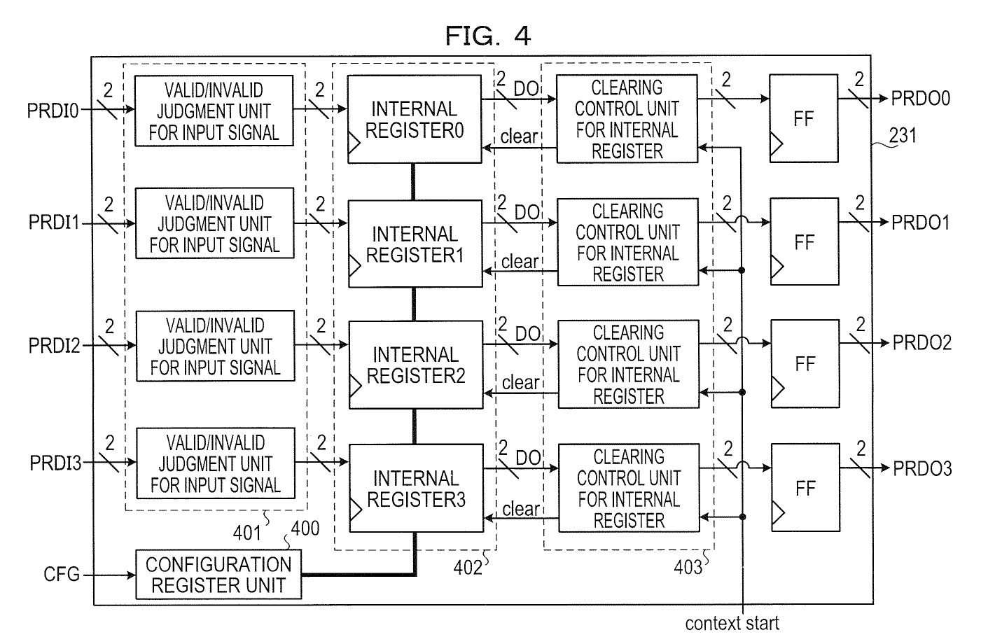

Next, the circuit configuration of the conditional branching register file 231 will be described. FIG. 4 is a block diagram showing the circuit configuration of the conditional branching register file. The conditional branching register file 231 has a configuration register unit 400 keeping the configuration data from the configuration memory 220, a valid/invalid judgment unit 401 for an input signal of each channel, an internal register 402, a clearing control unit 403 for the internal register, and an FF (Flip-flop).

In the example of FIG. 4, the conditional branching register file 231 has the internal registers 402 for four channels, so that the conditional branching register file 231 can handle up to four branches in the conditional branching computation. It should be noted that the input terminals PRDI and the output terminals PRDO are independent from each other for each channel. Thus, the input terminals PRDI and the output terminals PRDO can also have four or more channels. In addition, it may also be possible to employ multiple clusters, which constitute the reconfigurable circuits, so that the number of branching destinations can be increased.

Data input to each channel of the conditional branching register file 231 is the predicate signal of the cluster 200, which is the 2-bit signal as described above. A configuration setting may be input to the conditional branching register file 231 from the configuration register unit 400. The configuration setting is incorporated when the start instruction of the context, namely, the context start signal, is asserted.

The internal register 402 in the conditional branching register file 231 renews its value when the predicate signal 2′b=“11” or 2′b=“10” is input to the input terminal PRDI. The internal register 402 outputs the kept value, as one pulse, to the FF of the output unit when the context start signal is asserted. Then, the signal output to the FF is output via the output terminal PRDO. At this moment, all the values in the internal register 402 are renewed with “0” to be cleared using the clearing control unit for the internal register 403. It should be noted that the values in the internal register 402 can also be initialized by the configuration setting of the configuration register unit 400. This kind of initialization processing is used when the first context is started.

Next, the configuration setting of the configuration register unit 400 will be described. Following settings in the configuration setting can be set independently for each channel. These settings are set by the configuration data of the dynamically switched context.

(1) Invalidation Setting of the Input Predicate Signal

This setting causes the predicate signal input from the input terminal PRDI to be handled as an invalid value. This setting can prevent the predicate signal kept in the internal register 402 from being renewed.

(2) Output/Non-Output Setting of the Internal Register Value at the Start of the Context

In a case where the setting is set to cause the value in the internal register 402 to be output at the start of the context, the data kept in the internal register 402 is written, as one pulse, to the FF, which is a stage prior to the output terminal PRDO. Simultaneously, the internal register 402 is cleared to ALL 0. On the other hand, in a case where the setting is set to cause the value in the internal register 402 not to be output at the start of the context, the value in the internal register 402 is not output to the FF in the conditional branching register file 331 even where the context start is asserted. That is, the value currently kept in the internal register 402 continues to be kept therein.

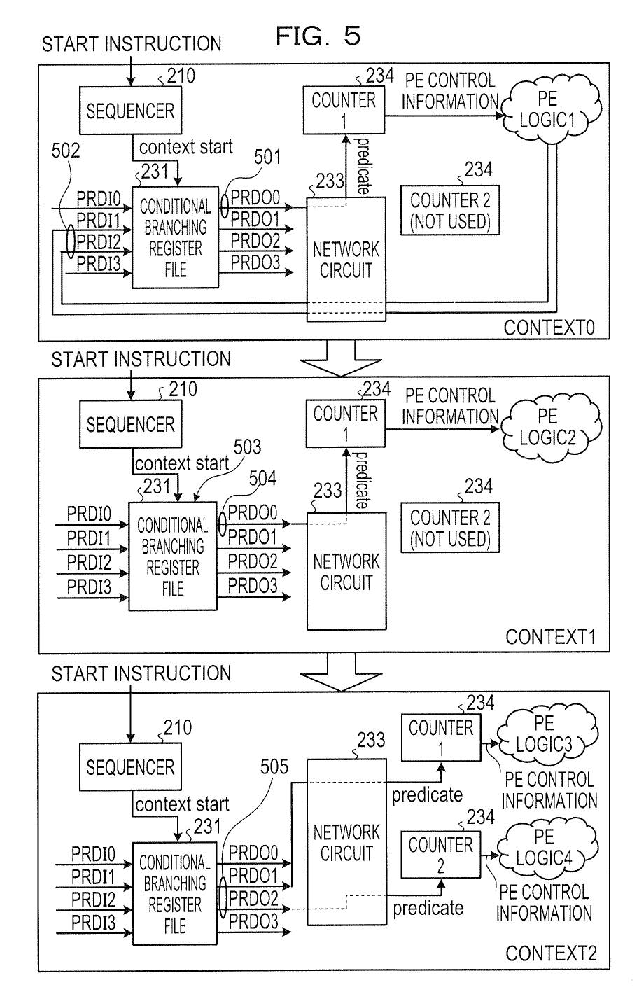

FIG. 5 is an illustration showing the usage procedure when data in the conditional branching register file are kept. For example, in the context switching as shown in FIG. 5, the value set by the configuration signal is output via the PRDO0 in the initial context, namely, context 0 (501). Then, the predicate signal is written to any one of PRDI1 and PRDI2 according to a computation result of the PE logic 1 in context 0 (502).

When the context is switched from context 0 to context 1, there may exist a case where the predicate signal kept in the conditional branching register file 231 is desired to be used as the start signal of the counter, not in subsequent context 1, but in context 2 subsequent thereto. At this moment, the output/non-output setting of the value of the internal register 402 is used, so that the predicate signal kept in the conditional branching register file 231 is kept in the internal register 402 as it is (503) In context1, any conditional branching computation does not occur, and accordingly, the predicate signal set by the configuration setting starts the first counter 234 (504).

Then, the predicate signal having been written to any one of PRDI1 and PRDI2 in context 0 can be output to either of the first counter 334 and the second counter 334 when the context is switched to context 2 (505). Thus, it is possible to set the output/non-output setting of the internal register value at a time of start of the context.

(3) Immediate Value Setting of the Internal Register Value

This is a setting for causing an operation wherein, instead of the value of the internal register 402, the immediate value set by the configuration setting of the configuration register unit 400 is passed, as one pulse, to the FF, which is the stage prior to the output terminal PRDO.

(4) Valid/Invalid Setting of the Immediate Value

This is a setting for validating or invalidating the incorporation of the immediate value setting in the configuration register unit 400 set through the above-described (3).

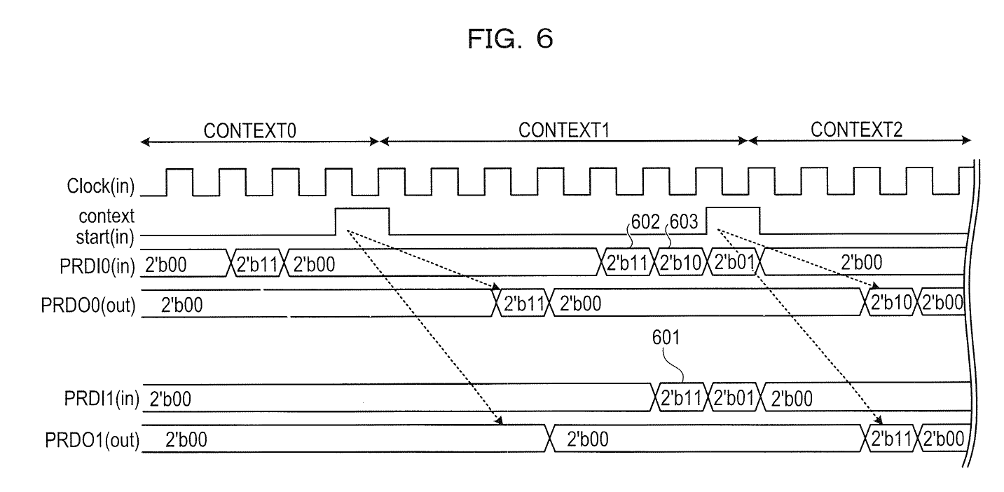

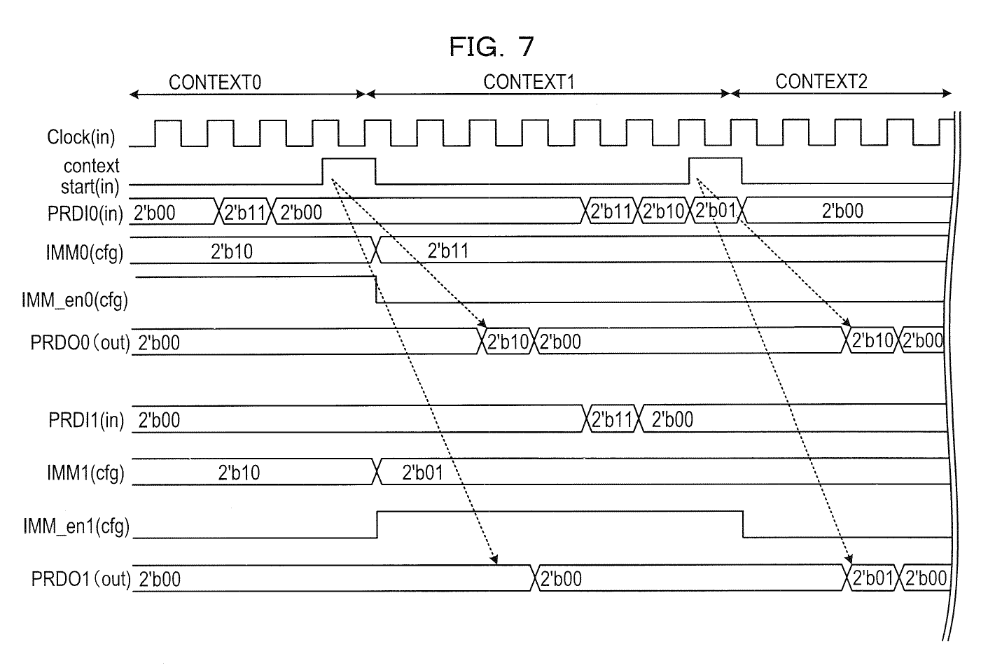

The above-described operation of the conditional branching register file 231 will be described using a timing chart. FIG. 6 is a timing chart showing the operation of the conditional branching register file. FIG. 7 is a timing chart showing the operation of the conditional branching register file including the immediate value output setting.

In the timing chart of FIG. 6, when the predicate signal of “11” is input to the input terminal PRDI1 in the conditional branching register file 231 (601), 2′b=“11” is kept in the internal register 402. Thereafter, because any valid data (“11” or “10”) is not input to PRDI1 until the context start is asserted, the register is not renewed, and the kept 2′b=“11” is output via the output terminal PRDO1 and is cleared to “00”. On the other hand, 2′b=“11” input to the input terminal PRDI0 is kept in the internal register 402 (602). Then, before the context start is asserted, 2′b=“10” is input to the input terminal PRDI0, and overwrites the internal register 502 (603). As a result, 2′b=“10” is output from the output terminal PRDO0. When the context is switched from context 1 to context 2, a new context start is asserted.

In the timing chart of FIG. 7, IMM_en0 (configuration data, hereinafter referred to as “cfg”) sets whether the immediate value of the configuration setting in the configuration register unit 400 is to be output or not. In a case where the setting is set to cause the immediate value to be output, IMM0 (cfg) is output as the immediate value. In this way, the context setting is set according to the setting in context 0. Thus, a degree of flexibility in implementation for each context can be improved.

### EXAMPLE

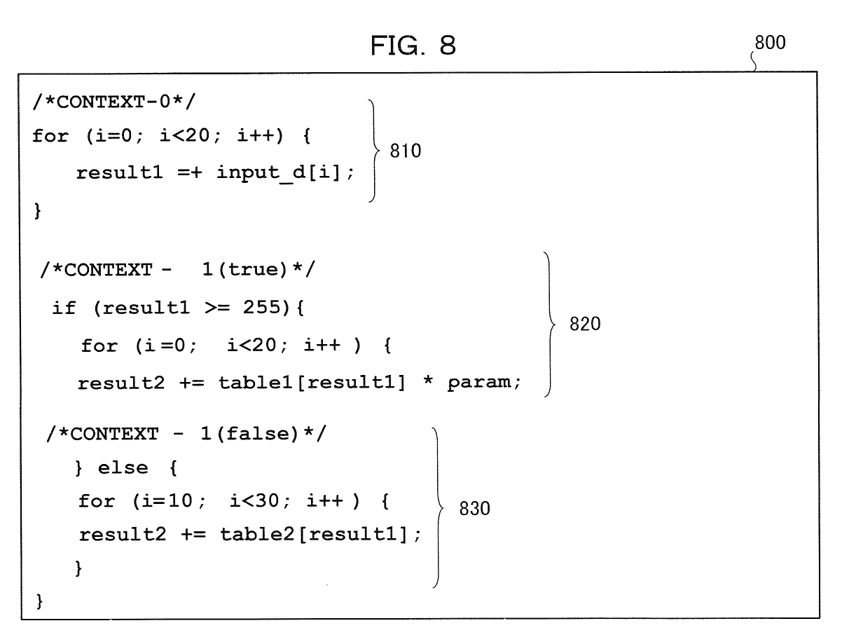

Next, an example will be described where the reconfigurable circuit is implemented with the context switching operation performed by a source code including the conditional branching processing. FIG. 8 is an example of a source code implementing the context switching in C language. In a source code 800 of FIG. 8, a context 0 portion 810 recites a processing for accumulating and adding input data, and the last portion recites a processing for comparing the accumulated and added value with a fixed value. Context 1 (true/false) portions 820, 830 switch the executed loop control according to the comparison result of context 0. That is, it is required to operate the counter corresponding to a processing of either of the context 1 (true) portion 820 and the context 1 (false) portion 830 according to the comparison result of context 0.

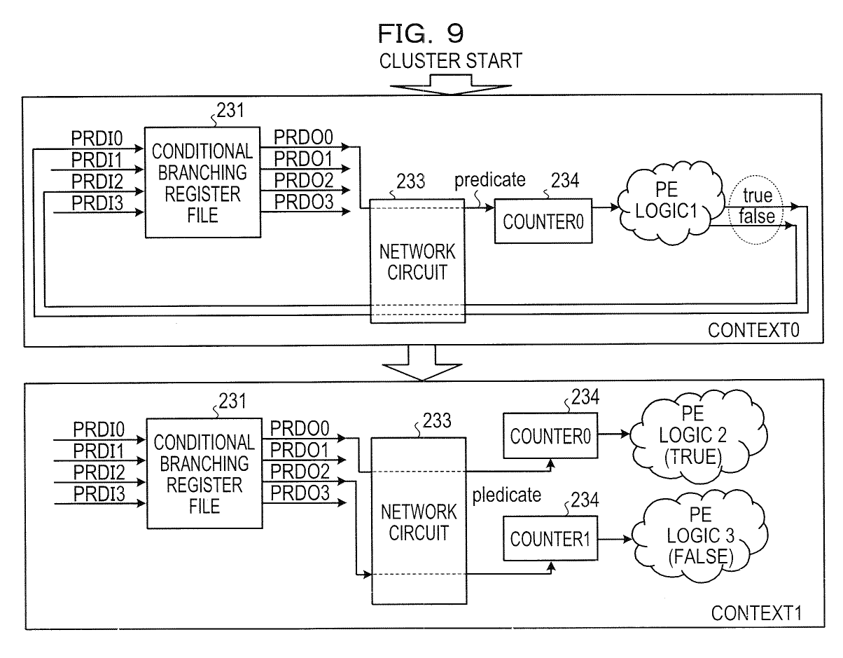

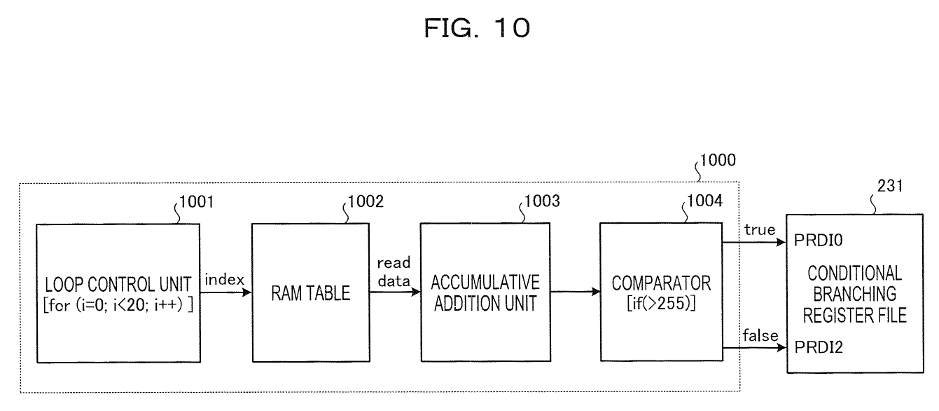

FIG. 9 is an illustration showing a generation procedure of the conditional branching signal for starting an address counter. FIG. 10 is a block diagram showing an example of an implementation of a circuit of context 0. As recited in the source code 800 of FIG. 8, ‘for’ loop control is performed in the initial context, namely, context 0. Thus, the output of the address counter is kept as input data (input_d), and an accumulative addition processing is performed on data kept in a RAM using the output of the address counter as an index of the RAM. This computation processing is achieved by a loop control unit 1001, a RAM table 1002, and an accumulative addition unit 1003 of a PE logic 1000 of FIG. 10

When a comparator 1004 compares the accumulative addition result with the fixed value (in the example, 255) and determines the comparison is true, the predicate signal “11” is written to PRDI0 of the conditional branching register file 231. When the comparator determines that the comparison is false, the predicate signal “11” is written to PRDI2 of the conditional branching register file 231. This comparison processing is achieved by the comparator 1004 of the PE logic 1000.

In the example as described above, the conditional branching instruction portion, namely, context 1 (true) and context 1 (false), can be realized with one context by using the conditional branching register file 231, which is a structure unique to this embodiment. Thus, it is possible to reduce the number of contexts and reduce time loss occurring between the context switchings.

As hereinabove described, according to aspects of this embodiment, it is possible to keep the computation result to cause the counter for a subsequent context to operate in a case where the conditional branching computation is performed. Thus, with only one context, a counter operation instruction can be given according to each branching result, even where contexts are not prepared for each conditional branch. In addition, according to this embodiment, the use of the conditional branching register file 231 eliminates a necessity to rewrite output destinations of the configuration data. Thus, it is possible to efficiently realize a processing including the conditional branching control with the minimum context.

It should be noted that the loop processing control method as described in this embodiment can be realized by causing a computer such as a personal computer, a workstation, and the like to execute a previously prepared program. This program may be recorded on a computer-readable recording medium such as hard disk, flexible disk, CD-ROM, MO, DVD, and the like, and the computer executes the program by reading out the program from the recording medium. Alternatively, this program may be a transmission medium that can be distributed via a network such as Internet and the like.

Example embodiments of aspects of the present invention have now been described in accordance with the above advantages. It will be appreciated that these examples are merely illustrative of aspects of the present invention. Many variations and modifications will be apparent to those skilled in the art.

What is claimed is:

1. A counter control circuit for controlling operation of a counter arranged in a dynamic reconfigurable circuit for executing an arbitrary instruction by dynamically switching an aggregation of reconfigurable processing elements (hereinafter referred to as “PEs”) according to a context reciting a processing content of the PE and a connection content between the PEs, the counter control circuit comprising:
keeping means for keeping an operation instruction signal when the PE executing a conditional branching computation outputs, in a context being adapted to the dynamic reconfigurable circuit, the operation instruction signal of the counter for a subsequent context;
output means for outputting the operation instruction signal kept in the keeping means to the counter; and
control means for causing the output means to output the operation instruction signal when the context being adapted to the dynamic reconfigurable circuit is switched to the subsequent context.

2. The counter control circuit according to claim 1, wherein in the context being adapted to the dynamic reconfigurable circuit, the keeping means keeps the operation instruction signal when the PE executing a loop processing computation outputs the operation instruction signal of the counter, and wherein when the PE executing the loop processing computation completes the computation, the control means causes the output means to output the operation instruction signal output from the PE executing the loop processing computation.

3. The counter control circuit according to claim 2 further comprising:
setting means for receiving an output prohibition setting that prohibits the output means from outputting the operation instruction signal,
wherein when the setting means receives the output prohibition setting, the control means prohibits the output means from outputting the operation instruction signal when the output means completes the loop processing computation of the context being applied.

4. The counter control circuit according to claim 1, wherein the keeping means discards the operation instruction signal when the output means outputs the operation instruction signal through the control of the control means.

5. The counter control circuit according to claim 1 further comprising:
setting means for receiving an output prohibition setting that prohibits the output means from outputting the operation instruction signal,
wherein when the setting means receives the output prohibition setting, the control means prohibits the output means from outputting the operation instruction signal when the context being adapted to the dynamic reconfigurable circuit is switched to the subsequent context.

6. The counter control circuit according to claim 1, wherein the dynamic reconfigurable circuit includes a plurality of counters corresponding to branching results of the conditional branching computation included in the context being applied, and wherein in a case where the context being adapted to the dynamic reconfigurable circuit is switched to the subsequent context, the control means causes the operation instruction signal output from the PE executing the conditional branching computation to be output to one of the plurality of counters corresponding to the branching result.

7. A dynamic reconfigurable circuit executing an arbitrary processing by dynamically switching an aggregation of reconfigurable processing elements (hereinafter referred to as “PEs”) according to a context reciting a processing content of the PE and a connection content between the PEs, the dynamic reconfigurable circuit comprising:
a counter for counting operations of the PE specified by the context; and
a counter control circuit for controlling the operation of the counter,
wherein the counter control circuit includes:
keeping means for keeping an operation instruction signal when the PE executing a conditional branching computation outputs, in a context being adapted to the dynamic reconfigurable circuit, the operation instruction signal of the counter for a subsequent context;
output means for outputting the operation instruction signal kept in the keeping means to the counter; and
control means for causing the output means to output the operation instruction signal when the context being adapted to the dynamic reconfigurable circuit is switched to the subsequent context.

8. The dynamic reconfigurable circuit according to claim 7, wherein the keeping means keeps the operation instruction signal when the PE executing a loop processing computation outputs, in the context being adapted to the dynamic reconfigurable circuit, the operation instruction signal of the counter, and wherein when the PE executing the loop processing computation completes the computation, the control means causes the output means to output the operation instruction signal output from the PE executing the loop processing computation.

9. The dynamic reconfigurable circuit according to claim 7, wherein the keeping means discards the operation instruction signal when the output means outputs the operation instruction signal through the control of the control means.

10. The dynamic reconfigurable circuit according to claim 7, wherein the counter control circuit further includes setting means for receiving an output prohibition setting that prohibits the output means from outputting the operation instruction signal, and wherein when the setting means receives the output prohibition setting, the control means prohibits the output means from outputting the operation instruction signal when the context being adapted to the dynamic reconfigurable circuit is switched to the subsequent context.

11. The dynamic reconfigurable circuit according to claim 8, wherein the counter control circuit further includes setting means for receiving an output prohibition setting that prohibits the output means from outputting the operation instruction signal, and wherein when the setting means receives the output prohibition setting, the control means prohibits the output means from outputting the operation instruction signal when the output means completes the loop processing computation of the context being applied.

12. The dynamic reconfigurable circuit according to claim 7, wherein the counter includes a plurality of counters corresponding to branching results of the conditional branching computation included in the context being applied, and wherein in the counter control circuit, when the context being adapted to the dynamic reconfigurable circuit is switched to the subsequent context, the control means controls the output means to output the operation instruction signal, output from the PE executing the conditional branching computation, to one of the plurality of counters corresponding to the branching result.

13. A loop processing control method for controlling a loop processing executed by a counter counting predetermined operations in a dynamic reconfigurable circuit for executing an arbitrary processing by dynamically switching an aggregation of reconfigurable processing elements (hereinafter referred to as “PEs”) and a counter circuit according to a context reciting a processing content of the PE and a connection content between the PEs, the loop processing control method comprising the steps of:
keeping an operation instruction signal when the PE executing a conditional branching computation outputs, in a context being adapted to the dynamic reconfigurable circuit, the operation instruction signal of the counter for a subsequent context;
detecting a switching from the context being adapted to the dynamic reconfigurable circuit to the subsequent context; and
outputting the operation instruction signal kept to the counter when the switching to the subsequent context is detected.

14. The loop processing control method according to claim 13, further comprising:
keeping the operation instruction signal when the PE executing the loop processing computation outputs, in the context being adapted to the dynamic reconfigurable circuit, the operation instruction signal of the counter, and
detecting a completion of a computation of the PE executing the loop processing computation, and
when the completion of the computation of the PE executing the loop processing computation is detected, outputting the operation instruction signal output from the PE executing the loop processing computation.
